(19) United States
(12) Patent Application Publication
(10) Pub. No.: US 2009/0202426 A1
(43) Pub. Date: Aug. 13, 2009

(54) Method for producing dielectric powder

(75) Inventors: Tomohiro Yamashita, Tokyo (JP); Hiroshi Sasaki, Tokyo (JP); Tomoaki Nonaka, Tokyo (JP); Shinsuke Hashimoto, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/320,329

(22) Filed: Jan. 23, 2009

(30) Foreign Application Priority Data
Feb. 13, 2008 (JP) 2008-031509

(51) Int. Cl. C01G 23/04

(52) U.S. Cl. 423/598

(57) ABSTRACT

Method for producing dielectric powder comprising steps of;
preparing titanium dioxide powder having sum of surface chlorine amount and internal chlorine amount of 2000 ppm or less, surface chlorinity of 120 ppm or less, rutilated ratio of 30% or less, BET specific surface area of 30 m²/g or more;
preparing barium compound powder to produce barium oxide by thermolysis;
preparing powder mixture of titanium dioxide powder and barium compound powder; and
heat treating the powder mixture.

### BACKGROUND OF THE INVENTION

1. Field of the Invention

The present invention relates to method for producing dielectric powder, typically by barium titanate powder.

2. Description of the Related Art

Ceramics such as BaTiO₃, (Ba, Sr)TiO₃, (Ba, Ca)TiO₃, (Ba, Sr) (Ti, Zr)O₃, (Ba, Ca) (Ti, Zr)O₃ and the like are widely used for dielectric substance of ceramic capacitor. Dielectric layer is obtained by forming green sheet from paste which includes dielectric powder, and sintering thereof. The dielectric powder used for such purpose is generally produced by solid phase synthetic method. For example, barium titanate (BaTiO₃) is obtained from mixing barium carbonate (BaCO₃) powder and titanium dioxide (TiO₂) powder by wet method, after drying, the mixed powder is thermally treated (preliminary firing) at 900 to 1200° C., chemical reacting barium carbonate particles and titanium dioxide particles under solid phase. When synthesizing (Ba, Sr)TiO₃, (Ba, Ca)TiO₃, (Ba, Sr) (Ti, Zr)O₃, (Ba, Ca) (Ti, Zr)O₃ and the like, compounds to be Sr source, Ca source, Zr sources are added at solid phase reaction, or after synthesizing barium titanate, further adding compounds to be Sr source, Ca source, Zr sources, then thermally treating (firing).

Such the barium titanate powder used for ceramic raw material powder for obtaining dielectric substance in a multilayered ceramic capacitor is required to be particulate further and is required to have high tetragonal crystallinity (high tetragonality) in accordance with thinning of ceramic layers between internal electrodes.

In solid phase reaction, as titanium dioxide, in order for preventing deterioration of properties of an obtained dielectric ceramics, high purity titanium dioxide which is obtained from heat decomposition of titanium tetrachloride is used typically. In this case, crystal form of the obtained titanium dioxide is that, although it is different by thermal decomposition condition, when a normal thermal treating condition is applied, a rutile type is predominant in general, since the rutilated ratio becomes higher.

However, the rutile type titanium dioxide powder is less reactive, also tetragonality of the obtained barium titanate becomes lower. When the tetragonality of the barium titanate is lower, for example, in the case it is used as raw material powder of the dielectric substance for preparing a multilayer ceramic capacity, solid dissolving of added components to barium titanate easily occurred in a firing process. Therefore, a sintered body having core-shell structure is hardly obtained after firing, and hence, it brings a problem that capacitance temperature property of the obtained multilayered ceramic capacitor becomes worse.

Also, even if the tetragonality of barium titanate is high, but a primary particle diameter of the raw material powder is larger, credibility of the multilayer ceramic capacitor is lowered due to thinning of the dielectric body ceramic layer. Also, in the thinning of the dielectric layer, because not only the primary particle size of the raw material powder, but also distribution is important factor, it is necessary that high tetragonality and better particle size distribution of the barium titanate.

Note that, for increasing the tetragonality of the barium titanate, it is effective to increase heat treatment temperature in a solid phase reaction method, which include blending barium compound such as barium carbonate and titanium dioxide and thermally treating, to thereby synthesizing barium titanate. However, when the thermal treatment temperature is increased in this manner, growing of particles and aggregation of the particles are occurred, there is a problem that atomization of the obtained barium titanate powder becomes harder. Also, in case of atomization by pulverization of barium titanate having high crystalline, for example, when fine particles are tried to be obtained by wet grinding, since dispersion factor is added in addition to particle distribution before grinding, it is not easy that particle size distribution is excellent and is not easy to prevent deterioration of dielectric property by grinding damage.

In order to solve these problems, as a method for producing barium titanate using titanium dioxide having high reactivity and low rutilated ratio (high changing ratio to anatase), a method is disclosed wherein blending barium compound which generates barium oxide by heating decomposition and titanium dioxide having rutilated ratio of 30% or less evaluated by X-ray diffractometry and having specific surface area of 5 m²/g or more evaluated by BET method, and thermal treating (calcining) (Patent Document 1).

By this method, barium titanate powder having high tetragonality and small particle size can be obtained, because anatase type titanium dioxide particulate having high reactivity is used.

However, in recent years, downsizing of electronic equipments is accelerated, further thinning for dielectric layer is required in a multilayer type ceramic capacitor. For this reason, further atomization for titanium dioxide powder is required, which is raw material of the dielectric powder. Namely, the titanium dioxide as raw material is required to maintain its particle size and distribution during thermally treating the barium titanate, and capable of giving high crystalline and unified particle size barium titanate.

As roughly divided, there are two methods for manufacturing titanium dioxide, namely a liquid phase method in which titanium tetrachloride or sulfuric titanyl are hydrolyzed and a vapor phase method in which titanium tetrachloride is reacted with oxidizing gas such as oxygen or moisture vapor and the like. The titanium dioxide according to the liquid phase method may obtain anatase as a main phase, but it will inevitably be sol or slurry condition. In case of using this condition, it is limited in usage.

On the contrary, producing titanium dioxide by the vapor phase method wherein titanium tetrachloride is raw material, ultrafine particle can easily be obtained, for example, the specific surface area is 20 m²/g or more and fine particle size distribution, and it has been possible that anatase is as a main phase. However, chloride derived from raw material source remains in the titanium dioxide.

Therefore, in the titanium dioxide produced by the vapor phase method, it becomes necessary to dechlorinate by heating in some cases. However, the ultrafine particle titanium dioxide tends to be lower the surface specific area because sintering each particles progress by heating for lower chlorination, also there are sometimes result in conversion of crystal form from anatase type to rutile type. For preventing the lowering surface specific area and crystal form conversion, it has no other choice to heat at lower temperature or short time, however dechrolination cannot be made sufficiently.
[Patent Document 1] JP Patent Laid Open No. 2002-255552

### DISCLOSURE OF INVENTION

### Problems to be Solved by the Invention

The present invention is made by considering the above mentioned conventional arts, aims to provide manufacturing method which is available to produce ultrafine dielectric powder, particularly, barium titanate powder with using ultrafine titanium dioxide having low rutilated ratio (high anatase ratio) and high reactivity.

Keen examining to achieve the purpose, inventors of the present invention have found that grain growth of the barium titanate is influenced by chlorine residual, when the chlorine residual is large amount, grain growth of the barium titanate occurs easily, and it is hard to produce ultrafine powder. However, when progressing the lowering chlorine by heating the titanium dioxide, sintering the particles and conversion to the rutile type are occurred as mentioned above, it becomes hard to producing the fine particle barium titanate, and the tetragonality is lowered.

Under the circumstances, as a result of further deliberation, the present inventors have found that grain growth of the titanium dioxide and barium titanate caused by chlorine residual are induced by mainly surface chlorine of titanium dioxide particles. In normally, it is known that hydroxyl group (OH group) is bonded with titanium atom on a surface of the titanium dioxide particle, however, in case that the surface chlorine as impurity is large amount, it is considered that chlorine ion of the impurity (Cl group) is bonded, instead of the hydroxyl group. Namely, in the titanium dioxide, for example, having specific surface area as large as 30 m²/g, in case that the impurity chlorine of the surface is 150 ppm, it corresponds 5 ppm·g/m² per specific surface area. It is considered that, in a producing process of the barium titanate, this surface chlorine becomes core which induces abnormal growth by bonding titanium dioxide particles having uniform distribution. It is considered that the abnormal growth deteriorates the distribution of particle size of the titanium dioxide particles, and further induces abnormal growth of barium titanate to thereby deteriorate the particle size distribution of the resulting barium titanate. The inventors have reached idea to following mentioned producing method, on the basis of the above knowledge.

### Means for Solving the Problems

The present invention solving the above problems includes following mentioned matters as gist.
(1) Method for producing dielectric powder comprising steps of; preparing titanium dioxide powder having sum of surface chlorine amount and internal chlorine amount of 2000 ppm or less, surface chlorinity of 120 ppm or less, rutilated ratio of 30% or less, BET specific surface area of 30 m²/g or more;

preparing barium compound powder to produce barium oxide by thermolysis;

preparing powder mixture of titanium dioxide powder and barium compound powder; and

heat treating the powder mixture.
(2) Method for producing dielectric powder as set forth in (1), wherein;

weight ratio of surface chlorine amount and internal chlorine amount (surface chlorine amount/internal chlorine amount) of said titanium dioxide powder is 0.15 or less.
(3) Dielectric powder obtained from the producing method as set forth in (1).
(4) Dielectric powder as set forth in (3), wherein;

BET specific surface area is 4 m²/g ore more, c/a is 1.008 or more.
(5) Inhibitor composed of dielectric powder having BET specific surface area is 10 m²/g or more as set forth in (3).

### EFFECTS OF THE INVENTION

In accordance with the present invention, particle growth at the time of producing barium titanate is inhibited, and the barium titanate powder having fine particles and uniform grain properties with high tetragonality can be obtained.

### BEST MODE FOR CARRYING THE INVENTION

Below, the present invention will be explained including its best mode. In a following specification, although it will be explained with an example of producing barium titanate particularly as dielectric powder, the producing method of the present invention may be applied with various kinds of dielectric powder producing method comprising heat treatment for mixed powder including titanium dioxide powder and barium compound powder, such as (Ba, Sr)TiO₃, (Ba, Ca)TiO₃, (Ba, Sr) (Ti, Zr)O₃, (Ba, Ca) (Ti, Zr)O₃ and the like.

The producing method for barium titanate of the present invention includes a heat treating process for the mixed powder of the titanium dioxide powder and the barium compound powder.

The titanium dioxide powder used as raw material has sum of surface chlorine amount and internal chlorine amount (total chlorine amount) of 2000 ppm or less, preferably 1000 ppm or less, further preferably 500 ppm or less. Although the lower total chlorine amount is preferable, when the lower chlorination is excessive, sintering the titanium dioxide particles and conversion to the rutile type are occurred, as mentioned above. Also, it is not easy to prepare fine particles (for example, specific surface area is 30 m²/g or more) having high anatase content rate as well as good particle size distribution, and there is limit for purification by extracting chlorine process only. Therefore, it is preferable to keep around 500 ppm, even in case that lowering the total chlorine amount.

Amount of surface chlorine of the titanium dioxide powder is 120 ppm or less, preferably 100 ppm or less, further preferably 50 ppm or less. Although the lower surface chlorine amount is preferable, upon achieving the purpose of the present invention, there is not much difference even if the surface chlorine amount is excessively low. Therefore, it is preferable to keep around 50 ppm to 100 ppm upon improving productivity.

The total chlorine amount is measured by ion chromatography. The surface chlorine amount is measured as stirring predetermined amount of titanium dioxide powder in purity water and eluting the surface chloride in the water, the eluted chlorine amount is quantitatively measured by the ion chromatography. The internal chlorine amount is a value that the surface chlorine amount is deducted from the total chlorine amount.

Also, rutilated ratio of the titanium dioxide powder is 30% or less, preferably 30% or less, further preferably 10% or less. In view of improving reactivity, although the lower rutilated ratio of the titanium dioxide powder is preferably, namely, the higher anatase ratio is preferable, there is not much difference of effects even if the rutilated ratio is excessively lowered upon achieving the purpose of the present invention. Therefore, for improving productivity, it is preferable to keep around 10%.

The rutilated ratio is evaluated from X-ray diffractometry of the titanium dioxide powder.

Also, BET specific surface area of the titanium dioxide is 30 m²/g or more, preferably 40 m²/g or more, further preferably 50 m²/g or more. In view of improving reactivity and obtaining fine barium titanate powder, although the higher BET specific surface area of the titanium dioxide powder is preferable, namely, the smaller particle size of the powder is preferable, there are sometimes difficulty to handling when the titanium dioxide is atomized excessively. Thus, in view of improving productivity, it is preferable to keep around 30 to 40 m²/g.

Further, weight ratio of the surface chlorine amount and the internal chlorine amount of the titanium dioxide powder (surface chlorine amount/the internal chlorine amount) is preferably 0.15 or less, further preferably 0.10 or less, particularly 0.05 or less. It is preferable the surface chlorine is deleted high degree than the internal chlorine.

Unless otherwise the above physical property is satisfied, producing method of the titanium dioxide used in the present invention is not particularly limited, commercial item and dechlorinated product thereof may be used. In particular, titanium dioxide powder which is obtained from vapor phase method wherein titanium tetrachloride is used as raw material, is preferably used since it is possible to obtain titanium dioxide fine powder having low chlorine content and high rutilated ratio.

A general method for producing titanium dioxide by the vapor phase method is conventionally known, and fine particle titanium dioxide may be obtained from oxidizing titanium tetrachloride as raw material under reaction condition about 600° C. to 1200° C. with using oxidizing gas such as oxygen or moisture vapor. When the reaction temperature is too high, titanium dioxide amount having high rutilated ratio tends to be increased. Therefore, the reaction is preferably be operated at 1000° C. or less. On the other hand, when the reaction temperature is too low, residual chlorine tends to be increased. Therefore, the reaction is preferably be operated under comparatively lower temperature and operating lowering chlorine treatment after obtaining titanium dioxide having low rutilated ratio. The lowering chlorine treatment is operated, for example, by heating the titanium dioxide powder.

Dechlorination of the titanium dioxide by heating is preferably operated at heating temperature 200° C. to 550° C. with contacting the titanium dioxide powder and moisture vapor so that mass ratio of water and titanium dioxide (=moisture vapor mass/titanium dioxide mass, herein after similar) is 0.01 or more. Further, preferably mass ratio of water and titanium dioxide is 0.04 or more and heating temperature is 250° C. to 450° C. When the heating temperature is too high, sintering the titanium dioxide particles is progressing, primary particle size tends to be ununiform and rutilated ratio tends to be increased. On the other hand, when the heating temperature is too low, dechlorination efficiency is lowered extremely.

Therefore, the heating condition is set upon considering chlorine amount, mutilated ratio, particles size. Dechlorination progresses by replace reaction of surface chlorine on titanium dioxide with water neighboring the particles or surface hydroxyl group of contiguous particles. When surface chlorine on titanium dioxide particle is replaced with water, dechlorination is made without particle growth, however, when replaced with the surface hydroxyl group of contiguous particles, particle growth is occurred simultaneously with dechlorination. Namely, in order to dechlorinate with preventing the particle growth, it is preferable to control mass ratio of water and titanium dioxide. When the mass ratio of water and titanium dioxide is 0.01 or more, effect to prevent the particle growth is acknowledged, preferably 0.01 or more and 3 or less, further preferably 0.05 or more and 2 or less, more preferably 0.2 or more and 1.8 or less.

Moisture vapor contacted with titanium dioxide is preferably used with mixing a gas capable of removing detached chlorine efficiently from the titanium dioxide to outside the system. As such gas, for example, air is exemplified. When using the air, moisture vapor is preferably included 0.1 volume % or more in the air, further preferably 5 volume % or more, particularly preferably 10 volume % to 80 volume %. The air including moisture vapor is preferably heated to 200° C. to 1000° C., more preferably 450° C. to 850° C.

In dechlorination of the titanium dioxide, as a method for removing chlorine detached from the titanium dioxide to outside the system, a method for decompression of an internal container used for dechlorination is effective. It is preferable that decompression degree of the internal container is 0.5 kPa or more. Further preferably, 0.5 kPa to 2 kPa. Here, the decompression degree shows a difference of an internal pressure decompressed and atmosphere pressure.

Considering from discharging amount of chlorine gas detached from the titanium dioxide in the decompressed container, 0.5 ka of the decompression degree is sufficient. Upper limit of the decompression degree is not particularly limited, however, if the decompression degree is increased, a large system of the decompression equipment is necessary. Further, if continuous dechlorination is operated, a facility to keep the decompression condition and a moving facility for the titanium dioxide from the decompression condition container to atmosphere are necessary which is costly disadvantageous. The upper limit of decompression degree not to require large system is 2 kPa.

According to the above heating, the total chlorine amount is reduced to a sufficient level. On the other hand, when the dechlorination is excess, phase conversion from anatase to rutile and the particle growth will be incurred. The present invention is made on the basis of knowledge that particle growth of titanium dioxide and barium titanate due to residual chlorine is mainly induced by surface chlorine of the titanium dioxide mainly. Therefore, after reducing the total chlorine amount to allowable level, it is not necessarily to lower the internal chlorine amount, and it is desirable to apply means for reducing the surface chlorine amount only.

Since the surface chlorine of the titanium dioxide powder may be removed by water washing and the like, the surface chlorine amount may be reduced by wet method. Wet dechlorination method is exemplified, for example, the titanium dioxide is suspended in purity water and chlorine diluted to liquid phase is removed to outside the system by ultrafilter membrane, reverse osmosis membrane, filter press and the like.

Also, respective contents of Fe, Al, Si and S in the titanate dioxide powder are preferably 0.01 wt % or less. When the respective contents of Fe, Si, Al and S excess 0.01 wt %, there will be not only blending ratio deviation of titanium dioxide and barium source, but also possibility of large influences are given to dielectric property. Although there is no restriction for a lower limit, it is preferable 0.0001wt % or more, in view of manufacturing cost.

As a barium compound to produce barium oxide by thermolysis, barium carbonate (BaCO₃), barium hydroxide (Ba(OH)₂) and the like may be used, also, more than two kinds of barium compound may be used in combination, in particular, barium carbonate powder is preferably used in view of easily obtainable. The barium carbonate powder is not particularly limited and conventionally known barium carbonate is used. However, in order to obtain fine barium titanate powder and accelerate solid phase reaction, it is preferable to use raw material powder having comparatively small particle size. Therefore, BET specific surface area of the barium carbonate powder used as raw material is preferably 10 to 50 m²/g, further preferably 10 to 40 m²/g, particularly preferably 20 to 40 m²/g.

By using the above mentioned specific titanium dioxide powder as raw material, the solid phase reaction is accelerated. Therefore, energy cost can be saved because the heat treating temperature can be lowered and the heat treatment time can be shortened. Also, by using titanium dioxide powder in which the residual chlorine amount, the surface chlorine amount is reduced as raw material, barium titanate powder having small particle size and unified grain property can be obtained, since abnormal particular growth at the heating treatment can be prevented. Further, since particle of the obtained barium titanate powder is grown by continuous heat treatment, barium titanate having desired particle size may easily be obtained by setting heat treatment time appropriately.

Also, proportion of barium carbonate powder and titanium dioxide powder in blended powder is not limited as far as it is near stoichiometry to produce barium titanate. Thus, Ba/Ti(molar ratio) in the blended powder may be 0.990 to 1.010. When Ba/Ti excesses 1.010, there is sometime non-reacted residual barium carbonate, when it is 0.990 or less, heterogeneous phase including Ti may be formed.

Mixing method for the blended powder is not particularly limited, and normal method such as using ball mill and the like may be applied. The obtained blended powder is heat treated after drying, to thereby forming barium titanate powder.

Heat treating condition is not particularly limited and any conventionally known method can be applied. As one example, maximum temperature at the time of heat treating is 700° C. or more, preferably 700 to 1100° C., more preferably 800 to 1000° C. Particularly, in the present invention, since titanium dioxide powder having high reactivity, low rutilated ratio and specific surface area of 30 m²/g or more is used, barium titanate fine powder having high tetragonality can be obtained even at 1000° C. or lower. Also, heat treating time is sufficient time for solid phase reaction of barium carbonate particle and titanium dioxide particle, generally, holding time at the above mentioned heat treating temperature is 0.5 to 4 hours, preferably 0.5 to 2 hours. Atmosphere during the heat treating is not particularly limited, it may be air-atmosphere, or may be gaseous atmosphere such as nitrogen or decompression and in vacuo. When heat treating temperature is too low, or heat treating time is too short, there is a risk that homogeneous barium titanium particle cannot be obtained.

In temperature rising process, temperature rising rate is preferably 1.5 to 20° C./min. Atmosphere during the temperature rising process is not particularly limited too, it may be air-atmosphere, or may be gaseous atmosphere such as nitrogen or decompression and in vacuo.

Such the heat treating may be carried in conventional electric furnace, and in case that large amount of blended powder is continuously heat treated, a rotary kiln may be used. The rotary kiln is an inclined heating pipe, it has a mechanism to rotate around center axis of the heating pipe. The blended powder thrown from an upper portion of the heating pipe is heated during moving process to lower direction in the pipe. Therefore, by controlling temperature of the heating pipe and passing time of blended powder, reaching temperature and temperature rising rate can be controlled appropriately. The temperature rising may be operated from a room temperature or the above temperature rising operation may be conducted after pre-heating the blended powder.

By such the heating treatment, barium titanate powder having small particle size may be obtained at an initial stage of the heating treatment. The barium titanate fine particle is growing by continuing the heat treatment. Thus, according to the present invention, barium titanate powder having desired particle size may be obtained by setting heat treating time appropriately. Particularly, according to the present invention, since barium titanate powder having homogenous particle properties can be obtained, abnormal particle growth is prevented, even operating particle growth. After the heat treatment, barium titanate powder is obtained by cooling. The cooling rate at this time is not particularly limited, it may be 3 to 100° C. in view of safety and the like.

According to the present invention, the particle growth at the time of producing barium titanate is prevented, in particular, at the initial stage of the heat treatment, barium titanate powder having fine particles, homogenous particle properties and high tetragonality can be obtained.

When it is used as raw material for dielectric capacitor, a specific surface area of barium titanate powder evaluated by BET method is preferably 4 m²/g or more, further preferably 5 m²/g or more. Also, c/a as being an index of tetragonality is preferably 1.008 or more, further preferably 1.009 or more. The specific surface area of the barium titanate powder may be controlled by suitably adjusting heat treatment temperature and heat treating time. Generally, when heating time is long, the particle size is increased according to particle growth, and hence the specific surface area is lowered.

The barium titanate powder obtained by the present invention is characterized by that particle size is particularly small. This barium titanate ultrafine particle is preferably used as inhibitor added to electrode layers of a multilayer ceramic capacitor. The inhibitor is added to the electrode layer, in order to strengthen adhesion between the dielectric layer and the electrode layer. By sintering the barium titanate of the electrode layer and the barium titanate of the dielectric layer, the adhesion property is strengthened. According to accelerating downsizing electronic devices, it is required further thinning the electrode layer in a multilayer ceramic capacitor. For this reason, with respect to the inhibitor added to the electrode layer, fine particle is desired. The barium titanate powder obtained by the present invention meets the requirement. Note that, although in case that using as inhibitor, the tetragonality is not required, it is required as being ultrafine particle. Thus, in case of using the barium titanate powder obtained by the present invention is used as inhibitor, BET specific surface area thereof is 10 m²/g or more, preferably 15 m²/g or more.

The barium titanate powder obtained by the present invention is ground according to necessity, after this, it is used as raw material for producing dielectric ceramics and added to paste as inhibitor for forming electrode layer. For producing dielectric ceramics, various of known methods are applied without any specific limitations. For example, subcomponents used for producing dielectric ceramics may be suitably selected in response to objected dielectric characteristics. Also, with respect to preparation of paste and green sheet, forming electrode and sintering green body, they may be operated suitably along with known methods.

Although the above mentioned present invention has been specified with an example of producing barium titanate as dielectric powder, the producing method of the present invention may be applied to methods for producing various dielectric powder having process of heat treating blended powder including titanium dioxide powder and barium compound powder. For example, when synthesizing (Ba, Sr)TiO₃, (Ba, Ca)TiO₃, (Ba, Sr) (Ti, Zr)O₃, (Ba, Ca) (Ti, Zr)O₃ and the like, compounds to be Sr source, Ca source, Zr sources are added at solid phase reaction, or after synthesizing barium titanate, compounds to be Sr source, Ca source, Zr sources are further added, then thermally treating (firing).

Below, although the present invention will be specified on the basis of further precise example, the present invention is not limited thereof.

Note that, in following examples and comparative examples, various of physical property evaluation are conducted as follows.

### (Total Chlorine Content)

Steam distilling 10 mg of titanium dioxide powder used as raw material at 1000° C., collecting decomposed matter into 5 ml hydrogen peroxide of 0.09%, and chlorine amount is determined by ion chromatography. By using DionexAS17 as column, KOH of 4-20 mM as eluent, it is measured at 1.0 ml/min of flow rate.

### (Surface Chlorine Amount)

5 g of titanate dioxide powder is thrown into 45 g purity water, after stirring and ultrasonic dispersion, clear supernatant liquid is recovered by centrifugal separation. After 50 fold dilution of the clear supernatant liquid, filtrating by 0.2 μm filter, chlorine amount is determined by ion chromatography. By using DionexAS17 as column, KOH of 1-30 mM as eluent, it is measured at 1.0 ml/min of flow rate.

### (X-Ray Diffractometry)

Rutilated ratio is evaluated by X-ray diffractometry of titanium dioxide used as ray material. An a-axis and a c-axis are determined by X-ray diffractometry of the obtained barium titanate powder, and c/a ratio as an index of tetragonality and crystal grain size are evaluated.

Specifically, it is measured by using full automated multipurpose X-ray diffractometry device D8 ADVANCE made by BRUKER AXS company at Cu—Kα, 40 kV, 40 mA, 20:20 to 120 deg, 1 dimensional fast detector LynxEye, divergence slit 0.5 deg, scattering slit 0.5 deg are used. Rietvelt analysis software (Topas (made by BrukerAXS)) is used for analysis.

### (Specific Surface Area)

Specific surface area of titanium dioxide powder as a raw material and specific surface area of barium titanate powder obtained by heat treatment are evaluated by BET method.

Specifically, it is measured under condition that 1 g powder amount, nitrogen gas atmosphere, one-point method, under deaeration condition at 300° C. with 15 min kept.

### (Specific Dielectric Constant of Barium Titanate)

For evaluating specific dielectric constant of barium titanate, specimen is prepared as follows. 10 wt % of PVA (polyvinyl alcohol resin) as binder is added to barium titanate powder obtained from an example and a comparison example of the present invention, a sample having disc shape of 12.5 mm diameter and 0.6 mm thickness is prepared by pressure forming. Then, as debinding treatment, heat treatment is performed in the air, at 400° C., for 4 hour keeping time. Then, heat treatment (firing) is performed under a condition that dielectric firing temperature T2, 1220° C. to 1280° C., which is available to obtain compact body and dielectric constant of barium titanate sufficiently. Condition is that environment: air atmosphere, keeping time: 2 hrs, temperature rate: 3.3° C./min.

Both surfaces of the obtained specific dielectric constant evaluation specimen, In—Ga is coated as electrodes. A diameter of the electrode is set as 6 mm.

With respect to the obtained respective specimens, specific dielectric constant (εs), ferroelectric transition temperature (Tc) were measured by a method shown as follows.

### (Specific Dielectric Constant εs)

A signal of 1 kHz frequency, input signal level (measured voltage) 1 Vrms was input to a capacitor specimen at room temperature 25° C. and in temperature bath −55° C. to 140° C. by a digital LCR meter (YHP 4284A), capacitance C and dielectric loss tan δ were measured. Then, the specific dielectric constant εS (no unit) is calculated based on thickness of dielectric specimen, effective electrode area and capacitance C obtained from measuring result. The ferroelectric transitional temperature is evaluated from peak temperature of the specific dielectric constant.

### (Thermal Analysis of Blended Powder)

TG analysis (thermo-gravimetric analysis) for blended powder of barium carbonate powder and titanate dioxide powder as raw materials is conducted. 30 to 50 mg is filled into a container made of Pt, and rising temperature up to 1000° C. by temperature rising rate 3.3° C./min. Atmosphere is set as air flow of 200 ml/min.

Also, as titanium dioxide powder, following is prepared.

TABLE 1

| | | | | | Comparative |
|---|---|---|---|---|---|
| | | | Example 1 | Example 2 | Example 1 |
| | | | TiO₂(A) | TiO₂(B) | TiO₂C |
| specific surface area | | [m²/g] | 33 | 31 | 31 |
| rutilated ratio | | [%] | 11 | 21 | 13 |
| chlorine content | total | [ppm] | 620 | 1700 | 670 |
| | internal | [ppm] | 540 | 1615 | 529 |
| | surface | [ppm] | 80 | 85 | 141 |

| | | | | |
|---|---|---|---|---|
| surface chlorine amount/ | [—] | 0.13 | 0.05 | 0.21 |
| internal chlorine amount | | | | |
| surface chlorine amount/ | [ppm · g/m²] | 2.4 | 2.7 | 4.5 |
| specific surface area | | | | |

### EXAMPLE 1

### [Preparation of Blended Powder]

Weighing barium carbonate powder having specific surface area so as to be 30 m²/g and titanium dioxide powder (TiO₂(A)) so as to be 0.997 Ba/Ti proportion, wet blending for 72 hours by a ball mill using zirconia (ZrO₂) medium, then the blended powder is obtained after drying. The wet blending is made under condition that slurry concentration is 40 wt %, adding 0.5 wt % polycarboxylate type dispersing agent. Here, since the titanium dioxide powder is fine particle having large specific surface area, it is necessary to blend the raw material sufficiently.

### (Heat Treatment for Blended Powder)

Temperature rising was made from a room temperature to heat treatment temperature T1 shown in Table 1, under air-atmosphere, temperature rising rate of 3.3° C./min (200° C./min) by an electric furnace (batch furnace). Then, keeping 2 hours at the heat treatment temperature, then after cooled by 3.3° C./min (200° C./min). This heat treatment condition is defined as a process (A). On the other hand, a heat treatment condition which is available to obtain further high tetragonality c/a is defined as a process (B). The process (B) is that atmosphere and a step for temperature rising during the heat treatment are optimized, the condition to keep 2 hours at the heat treatment temperature T1 is common with process (A).

The atmosphere and total amount of raw materials in the process (B) is controlled so that carbon dioxide (CO₂) concentration, which is generated from the raw material during the heat treatment, is 10 volume % or less. Also, in optimizing the temperature rising step, a step to keep at such temperature that reaction on titanium dioxide powder (TiO₂ particle) surface is accelerated, is introduced to improve crystallinity.

In the process (A), specific surface area, crystal grain size of the barium titanate powder obtained at respective thermal treatment temperature T1 are shown in Table 2, tetragonality value c/a obtained by powder X-ray diffractometry is shown in Table 3.

### EXAMPLE 2

Except for using TiO₂(B) as titanium dioxide powder, similar procedure as in Example 1 was repeated. Result is shown in Table 2.

### COMPARATIVE EXAMPLE 1

Except for using TiO₂(C) as titanium dioxide powder, similar procedure as in Example 1 was repeated. Result is shown in Table 2.

TABLE 2

| | Average particle size d_{—XRD} | | | Specific surface area | | | Average particle size d_{—BET} | | |
|---|---|---|---|---|---|---|---|---|---|
| | | | Comparative | | | Comparative | | | Comparative |
| Firing | Example | Example 2 | Example 1 | Example | Example | Example 1 | Example 1 | Example 2 | Example 1 |
| Temp. T1 | TiO₂(A) | TiO₂(B) | TiO₂(C) | TiO₂(A) | TiO₂(B) | TiO₂(C) | TiO₂(A) | TiO₂(B) | TiO₂(C) |
| [° C.] | [nm] | [nm] | [nm] | [m²/g] | [m2/g] | [m2/g] | [nm] | [nm] | [nm] |
| 600 | 11 | | 11 | 19.3 | | 18.8 | 54 | | 56 |
| 650 | 15 | | 14 | 18.1 | | 17.6 | 58 | | 60 |
| 700 | 19 | | 20 | 17.9 | | 17.4 | 59 | | 61 |
| 800 | 39 | | 40 | 16 | | 15.8 | 66 | | 67 |
| 900 | 57 | | 60 | 14 | | 13.2 | 75 | | 79 |
| 950 | 79 | 77 | 117 | 9.9 | 11.1 | 6.3 | 106 | 65 | 168 |
| 975 | 98 | 124 | 154 | 7.4 | 6.2 | 3 | 143 | 169 | 352 |
| 1000 | 136 | 225 | 153 | 2.7 | 2.5 | 2.6 | 396 | 421 | 404 |

Table 2 shows results for keeping 2 hours under the condition of the process (A) at heat treatment temperature T1. However, in case that the heat treatment temperature T1 is at 600° C, the yield of barium titanate is 35 wt %, 75 wt % at 700° C. and 95 wt % at 800° C., the reaction is not completely progressed 800° C. or less.

Here, an average particle size d_{—XRD} is calculated vale by Rietvelt analysis from a powder X-ray diffractometry, the average particle size d_{—BET} is a value calculated from a relation of d_{—BET}=6/(specific surface area x theoretical density). At this time, although the above value for average particle size is used, average particle sizes of specimens of Example 1 at T1 of 950° C., 975° C. and 1000° C. are 93 nm, 112 nm, 281 nm, respectively, and it has been confirmed that these are not much shifted as compared from above results. Calculation of the average particle size by SEM is made that extracting 300 or more particles from 20,000 to 20,000 times SEM image at random, by using analysis software for circle approximation.

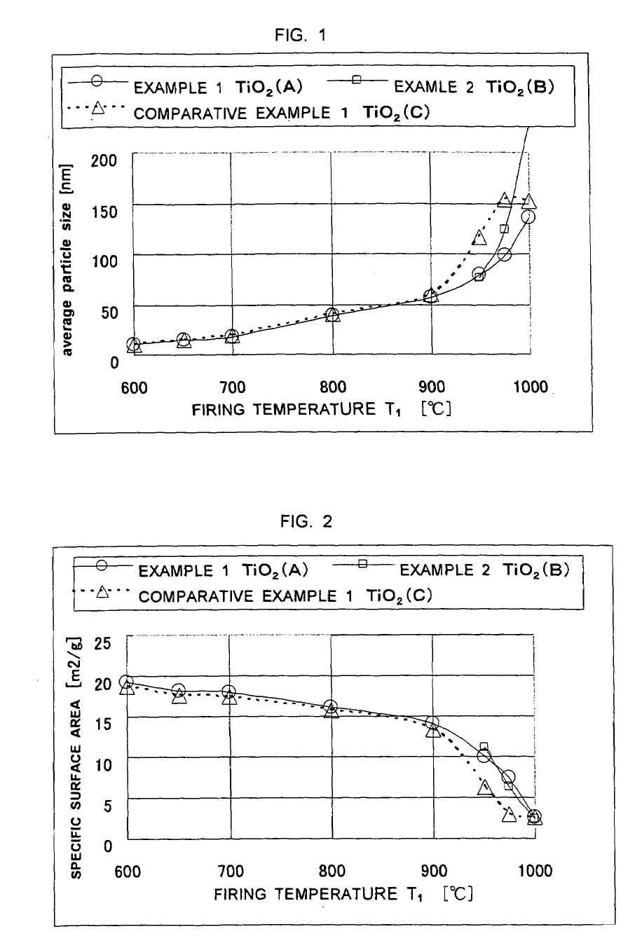

Relation of the heat treatment temperature T₁ and the average particle size d_{—XRD} is shown in FIG. 1, relation of the heat treatment temperature T1 and the specific surface area is shown in FIG. 2. It can be understood the average particle size of barium titanate is rapidly increased at heat treatment temperature of 900° C. or higher. As this result, it has been understood that particle growth of the examples are prohibited as compared with the comparative examples. By the present invention, it can be considered following results are obtained by reducing surface chlorine amount. Namely, surface chlorine as a core, which is, as an impurity, substituted with hydroxyl group of surface of titanium dioxide particle, bonds neighboring particles. As the result, homogeneous distribution of titanium dioxide particle cannot be maintained, and it could easily be abnormal growth condition. Therefore, as shown in Table 2, it is considered that the specific surface area of the comparative example 1 becomes smaller vicinity of 600 to 800° C. than that of the example 1. The neighboring titanium dioxide particles bonded via the surface impurity chlorine are in necking status, which deteriorates not particle distribution of titanium dioxide as raw material. Further, distinctive difference of average particle size of barium titanate was found at around 950° C. where particle growth of barium titanate particle is accelerated.

Therefore, even using titanium dioxide raw material of fine particle having homogeneous distribution, this cannot be effective to uniform particle size distribution of the reacted barium titanate powder.

In spite of the high rutilated ratio 21% of the example 2, and high internal impurity chlorine up to 1615 ppm, particle growth result is as similar with the example 1. Therefore, it has been cleared that abnormal particle growth can be prohibited by lowering the impurity chlorine content of the surface as the present invention.

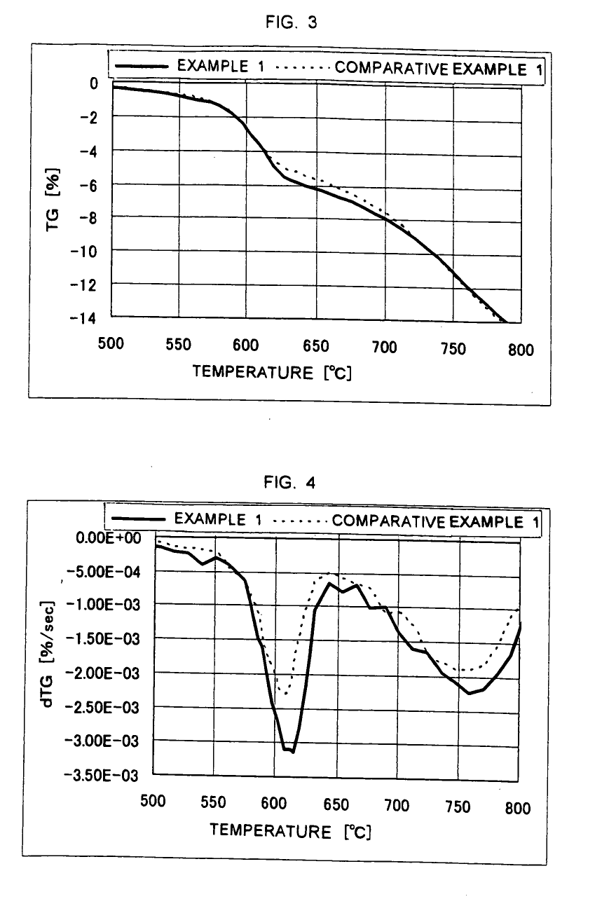

This phenomenon is considered to be appeared as a difference of TG analysis result. Results of TG analysis are shown in FIG. 3. and FIG. 4. FIG. 4 shows results of differential value of weight conversion. Difference of reaction can be found at a first gap of TG vicinity of 600° C. to 640° C. As similar to the above knowledge, in the comparative example including large amount of surface impurity chlorine, this difference is considered to be caused by lowering of surface area capacity barium carbonate and titanium dioxide due to bonding of titanium dioxide particle with neighboring particles.

The problems to be solved by the invention concern with surface contribution mainly, namely, the titanium dioxide having large specific surface area, for example 30 m²/g or more area. Also, it has been known, from crystal structures, anatase structure comprises large number of surface hydroxyl group than rutile structure. For obtaining high crystalline barium titanate, it is particularly effective when using raw material having large specific surface area and low rutilated ratio.

Next, characteristics of dielectric powder obtained by the present invention are examined.

### EXAMPLE 3

Except for using TiO₂(A) as titanium dioxide powder with heat treatment process (B), specimen of barium titanate powder is prepared as similar with Example. Results of EXAMPLE 1 and EXAMPLE 3 are shown in Table 3.

TABLE 3

| | | | | Average | | Specific | Average | | |
|---|---|---|---|---|---|---|---|---|---|
| | | | Firing | particle | c/a | surface | particle | | |
| | Raw Material | | temp. T1 | size d_{—XRD} | proportion | area | size d_{—BET} | | |
| | TiO2 | Process | [° C.] | [nm] | [—] | [m²/g] | [nm] | tetragonality | Usage |
| Example 1 | TiO₂(A) | process (A) | 1000 | 138 | 1.010 | 2.66 | 396 | A | base |
| | | | | | | | | | material |
| Example 1 | TiO₂(A) | process (A) | 900 | 60 | 1.008 | 14.03 | 75 | B | inhibitor |
| Example 1 | TiO₂(A) | process (A) | 800 | 40 | 1.005 | 16.04 | 66 | C | inhibitor |
| Example 3 | TiO₂(A) | process (B) | 925 | 142 | 1.010 | 4.00 | 263 | A | base |
| | | | | | | | | | material |
| Example 3 | TiO₂(A) | process (B) | 900 | 72 | 1.009 | 11.07 | 95 | A | base |
| | | | | | | | | | material |

In the table, as an index of tetragonality, c/a>1.009 is shown as “A”, c/a>1.007 is shown as “B”, c/a<1.007 is shown as “C”. The tetragonality “A” is preferable as dielectric material. Also, surface specific area 10 m²/g or more is preferable as inhibitor. In usage of the inhibitor, although tetragonality may be “B” or “C”, the higher is preferable.

In the present invention, by reducing the surface chlorine, abnormal particle growth can be prohibited and as Table 3, barium titanate powder having excellent property as dielectric powder or inhibitor can be obtained. Also, since the abnormal growth can be prohibited, it becomes easily controllable to dielectric powder being desired particle size and specific surface area by suitably controlling the thermal treatment temperature T₁ and the keeping time.

Dielectric characteristics of Example 1 and Example 3 are evaluated by the above mentioned specific dielectric constant evaluation. When dielectric firing temperature T₂ is set as 1280° C., result is shown in Table 4.

TABLE 4

| | | | dielectric powder characterist46 | | | dielectric characteristic (25° | | |
|---|---|---|---|---|---|---|---|---|
| | Firing | | Average | | Specific | | | transition |
| | temp. | | particle | c/a | surface | | | temp. |
| | T1 | | size d_{—XRD} | proportion | area | εs (1 kHz) | tanδ | Tc |
| | [° C.] | Process | [nm] | [—] | [m²/g] | [—] | [%] | [° C.] |
| Example 1 | 1000 | process (A) | 136 | 1.010 | 2.7 | 3976 | 2.4 | 125 |
| Example 2 | 925 | process (B) | 142 | 1.010 | 4.0 | 5721 | 3.4 | 125 |
| Example 3 | 900 | process © | 72 | 1.009 | 11.1 | 5980 | 3.7 | 125 |

It has been understood that barium titanate obtained by the present invention has sufficient properties as dielectric material. Therefore, fine particle dielectric powder having high tetragonality can be obtained with preventing abnormal particle growth by the present invention which contributes to make possible further thinner of multilayer ceramic capacitor.

### BRIEF EXPLANATION OF DRAWINGS

[FIG. 1] Relation of thermal treatment temperature T₁ and average particle size d_{—xrd}

[FIG. 2] Relation of thermal treatment temperature T₁ and specific surface area

[FIG. 3] Thermal analysis result of blended powder of example 1 and comparative example 1.

[FIG. 4] Thermal analysis result of blended powder of example 1 and comparative example 1 (differential).

1. Method for producing dielectric powder comprising steps of; preparing titanium dioxide powder having sum of surface chlorine amount and internal chlorine amount of 2000 ppm or less, surface chlorinity of 120 ppm or less, rutilated ratio of 30% or less, BET specific surface area of 30 m²/g or more;
preparing barium compound powder to produce barium oxide by thermolysis;
preparing powder mixture of titanium dioxide powder and barium compound powder; and
heat treating the powder mixture.

2. Method for producing dielectric powder as set forth in claim 1, wherein;
weight ratio of surface chlorine amount and internal chlorine amount (surface chlorine amount/internal chlorine amount) of said titanium dioxide powder is 0.15 or less.

3. Dielectric powder obtained from the producing method as set forth in claim 1.

4. Dielectric powder as set forth in claim 3, wherein;
BET specific surface area is 4 m²/g ore more, c/a is 1.008 or more.

5. Inhibitor composed of dielectric powder having BET specific surface area is 1Om²/g or more as set forth in claim 3.
